(19) United States
(12) Patent Application Publication
(10) Pub. No.: US 2002/0069899 A1
(43) Pub. Date: Jun. 13, 2002

(54) Method and apparatus for removing adhered moisture form a wafer

(76) Inventors: Steven Verhaverbeke Verhaverbeke, San Fransisco, CA (US); J. Kelly Truman, Morgan Hill, CA (US)

Correspondence Address: Michael A. Bernadicou, APPLIED MATERIALS, INC., Patent Counsel, Legal Affairs Department, P.O. Box 450A, Santa Clara, CA, 95052, US

(21) Appl. No.: 09/891,259

(22) Filed: Jun. 25, 2001

Related U.S. Application Data
(60) Provisional application No. 60/214,073, filed on Jun. 26, 2000.

(51) Int. Cl. B08B 3/02

(52) U.S. Cl. 134/30; 134/33; 34/58; 34/60

(57) ABSTRACT

The present invention is a method of reducing adhered moisture on a wafer. According to the present invention a wafer is first spun dry. After spinning the wafer dry the wafer is passed under a linear source of isopropyl alcohol (IPA) vapor.

This application claims the benefit of provisional application serial no. 60/214,073 filed Jun. 26, 2000 entitled METHOD AND APPARATUS FOR REMOVING ADHERED MOISTURE FROM A WAFER.

### BACKGROUND OF THE INVENTION

1. Field of the Invention

The present invention relates to the field of semiconductor processing and more specifically to a method and apparatus for removing adhered moisture from a wafer in a single wafer cleaning apparatus.

2. Discussion of Related Art

Wet etching and wet cleaning of a silicon wafer is usually done by immersing the wafer into a liquid. This can also be done by spraying a liquid onto a wafer or batch of wafers. Wet wafer cleaning and etching is traditionally done in a batch mode where a plurality of wafers (e.g., 50-100 wafers) are processed simultaneously. Because of the need for a shorter cycle time in chip manufacturing there is a need for fast single wafer processing. After drying or even after an exposure to an ambient with a non-zero relative humidity, absorbed moisture will be present on the wafer surface. This absorbed moisture can interfere with subsequent processing steps.

Thus, there is a need for a single wafer tool that eliminates the adhered moisture on a wafer leftover from a drying process or from a clean room ambient.

### SUMMARY OF THE INVENTION

The present invention is a method of reducing adhered moisture on a wafer. According to the present invention a wafer is first spun dry. After spinning the wafer dry the wafer is passed under a linear source of isopropyl alcohol (IPA) vapor.

### BRIEF DESCRIPTION OF THE DRAWINGS

FIG. 1 is a flow chart which illustrates the process of the present invention.

FIG. 2a is an illustration of a cross-sectional view showing the spin drying of a wafer.

FIG. 2b is an illustration of a cross-sectional view of showing the passing of a wafer beneath a linear source of IPA vapor.

FIG. 2c is an illustration of a cross-sectional view of showing a wafer after it has passed through a linear source of IPA vapor.

FIG. 3a is an illustration of a cross-sectional view of a linear IPA vapor source in accordance with the present invention.

FIG. 3b is an illustration of an overhead view of the IPA vapor source shown in FIG. 3a.

FIG. 4 is an illustration of a cross-sectional view of an alternative linear source of IPA vapor in accordance with the present invention.

FIG. 5 is a schematic representation of the relationship between adhered moisture on the surface of wafers and the relative humidity in the ambient.

### DETAILED DESCRIPTION OF THE PRESENT INVENTION

The present invention is a method and apparatus for removing adhered moisture from a wafer in a single wafer process. In the following description numerous specific details are set forth in order to provide a thorough understanding of the present invention. One of ordinary skill in the art will understand these specific details are for illustrative purposes only and are not intended to limit the scope of the present invention. Additionally, in other instances, well-know processing techniques and equipment have not been set forth in particular detail in order to not unnecessarily obscure the present invention.

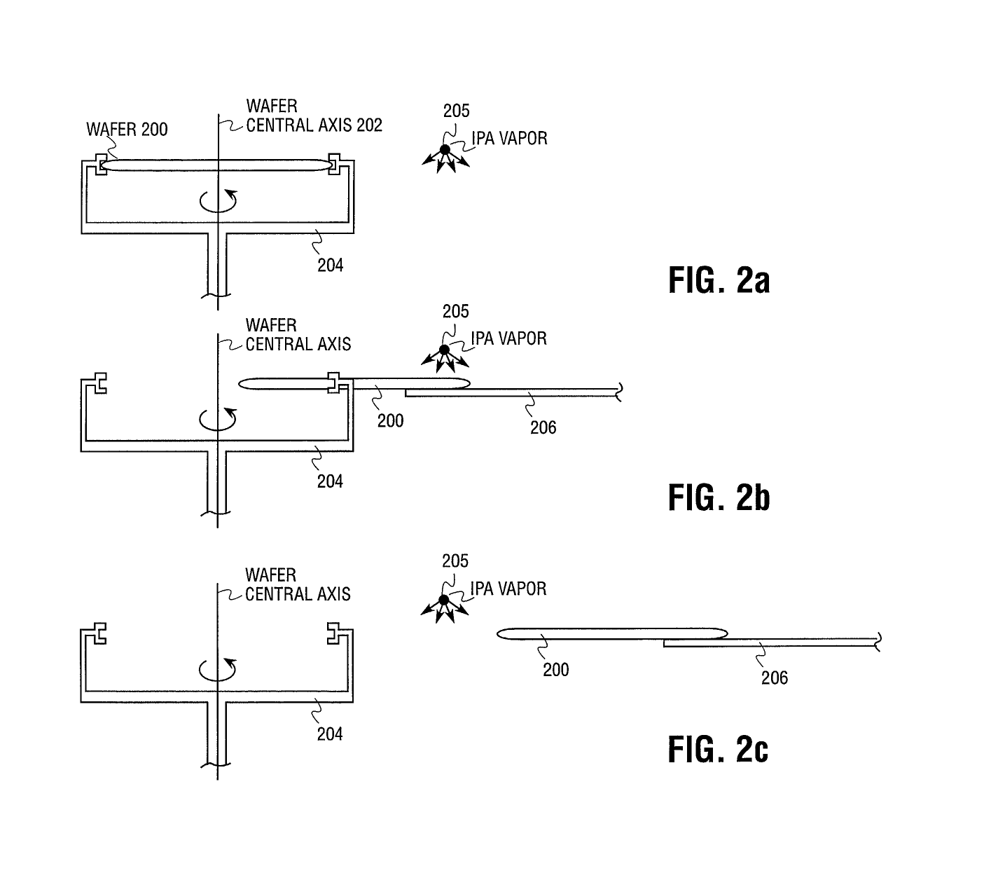

The present invention is a method and apparatus for removing adhered moisture from a wafer in a single wafer cleaning process. In wet cleaning and etching processes, wafers are exposed to chemicals and etchants. These chemicals and etchants are typically rinsed from the wafer with DI water. The present invention provides a method and apparatus for removing adhered moisture from the rinsed wafer 200. According to the present invention, after the wafer has been rinsed with for example, DI water, the wafer is dried as set forth in block 102 of flow chart 100 by spinning the wafer 200 at a high rate of speed about the wafer central axis as shown in FIG. 2a. Centrifugal forces from the spinning wafer remove the water from the surface. The wafer is spun dried at a rate and for a period of time until the wafer is considered dry by all standards used in the semiconductor industry. In an embodiment of the present invention the wafer is spun at a rate between 3000-6000 rpms for a period of time between 5-30 seconds. The wafer can be spun dried by, for example, clamping it to a wafer support 204 which can be rotated at the desired rate.

Unfortunately, however, because of the hydrodynamic boundary layer the water on the surface of the wafer does not move relative to the wafer and only the higher layers of water can be removed by the centrifugal force. Therefore, after the centrifugal spin drying, the wafer still contains a layer of moisture on its surface.

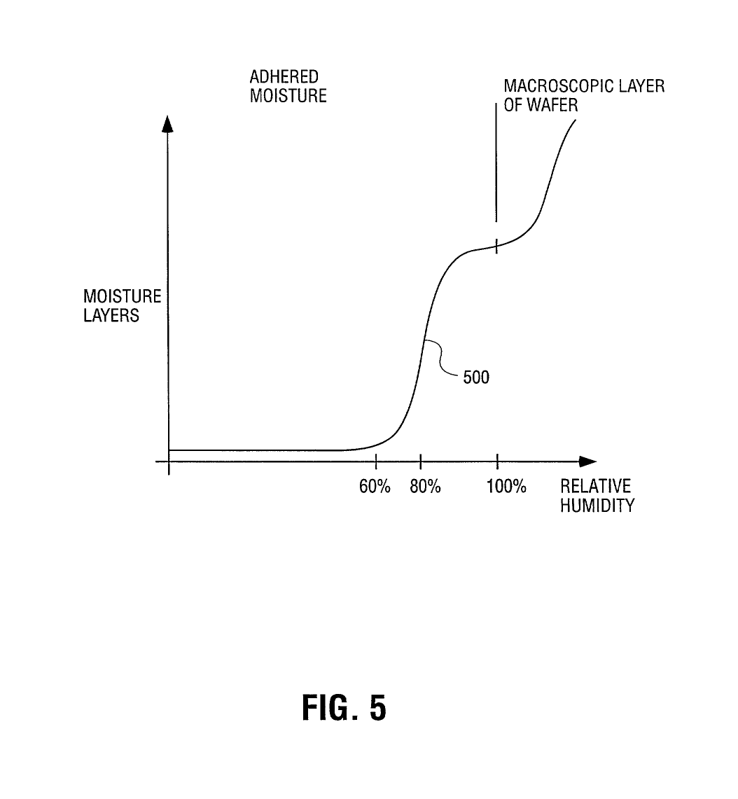

It is to be appreciated that any surface in an environment, which contains water vapor, will contain adhered moisture. Typically the layers of moisture on the wafer surface are dependent on the relative humidity of the environment in which the wafers are held. Only when the ambient is completely free of water vapor, will the surface not contain any adhered moisture. The typical relationship 500 between adhered moisture layers and relative humidity is schematically shown in FIG. 5. When the relative humidity in the ambient exceeds 60% the adhered moisture layers starts to increase dramatically. When relative humidity in the ambient exceeds 100% the adhered moisture layers will agglomerate and macroscopic condensation will occur on the wafer surface. In typical clean rooms the relative humidity is kept around 40%. The higher the humidity the lower the static electricity which is good for particle control. High humidity, however, causes problems in the lithography area because photoresist absorbs moisture and therefore the 40% relative humidity is a good compromise.

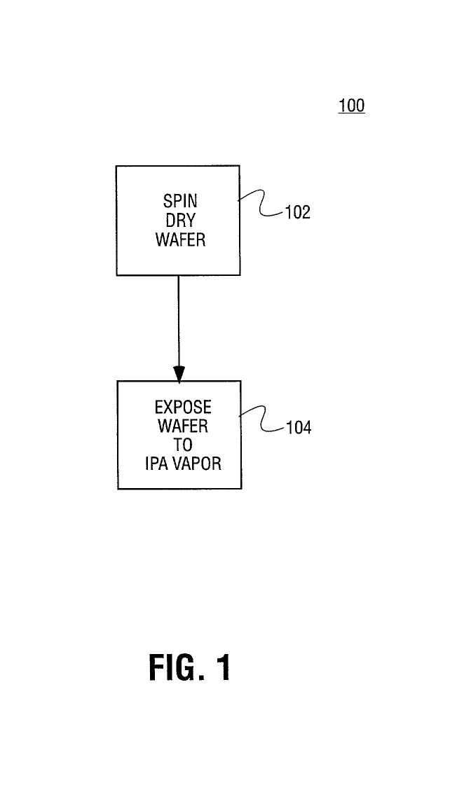

Thus although, after the spin dry, the wafer is considered dry by all standards used in the semiconductor industry, there are still some layers of residual moisture remnant on the wafer surface. Thus in the second step of the present invention as set forth in block 104 of flow chart 100 shown in FIG. 1, the already dried wafers are passed under a linear source 205 of isopropyl alcohol (IPA) vapor as shown in FIG. 2b. The IPA vapor adheres to the wafer surface by the linear movement of the wafer opposite to the linear IPA vapor source as shown in FIG. 2b and reduces the adhered moisture on the wafer by IPA vapor adhesion. The adhesion of IPA on the surface reduces the adhered moisture on the wafer surface. The linear IPA vapor source can be called an IPA knife. In an embodiment of the present invention the wafer is held by a robot blade 206 which moves the wafer linearly perpendicular to the IPA vapor source as shown in FIG. 2b. In an embodiment of the present invention the wafer is moved underneath the IPA vapor source at a rate on the order of 900 cm/minute. This fast rate is possible since the IPA knife adheres IPA to the wafer surface and is not used for drying. The wafer is already dry when it passes underneath the knife. This allows a passage under the IPA vapor knife for 300 mm wafer to be accomplished on the order of two seconds. If for some applications, more IPA has to be adhered to the wafer surface the linear speed can be reduced. In an embodiment of the present invention the linear vapor source has a length of at least the diameter of the wafer being processed so that the entire wafer is exposed to the IPA vapor.

In an embodiment of the present invention the wafer is passed beneath the linear IPA vapor source while the wafer is removed by a robot blade 206 from the chamber or apparatus in which the wafer was rinsed and spun dried. In this way, the IPA exposure and adhered moisture removal does not affect the throughput of the rinsing and drying process.

In an embodiment of the present invention the linear IPA vapor source 205 is contained inside the process chamber in which the wafer is rinsed and spun dry. In an alternative embodiment of the present invention the IPA vapor source 205 is contained in a transfer chamber which contains the transfer robot for transferring wafers into and out of the process chamber where wafers are rinsed and spun dry. Alternative placements of the IPA vapor source 205 can be utilized without departing from the scope of the present invention.

Once the wafers have completely passed through the linear IPA vapor source, as shown in FIG. 2c, the adhered moisture on the wafer is reduced. After IPA vapor treatment, the wafers are ready for subsequent processing. Ideally, the wafer should be held in an ambient with low relative humidity. Alternatively, the wafers can be held in an ambient with a normal relative humidity, but are transported quickly to the next process so that its adherence of moisture is reduced. Alternatively, the ambient in which the wafers are contained or the wafers themselves can be heated to reduce adherence of moisture.

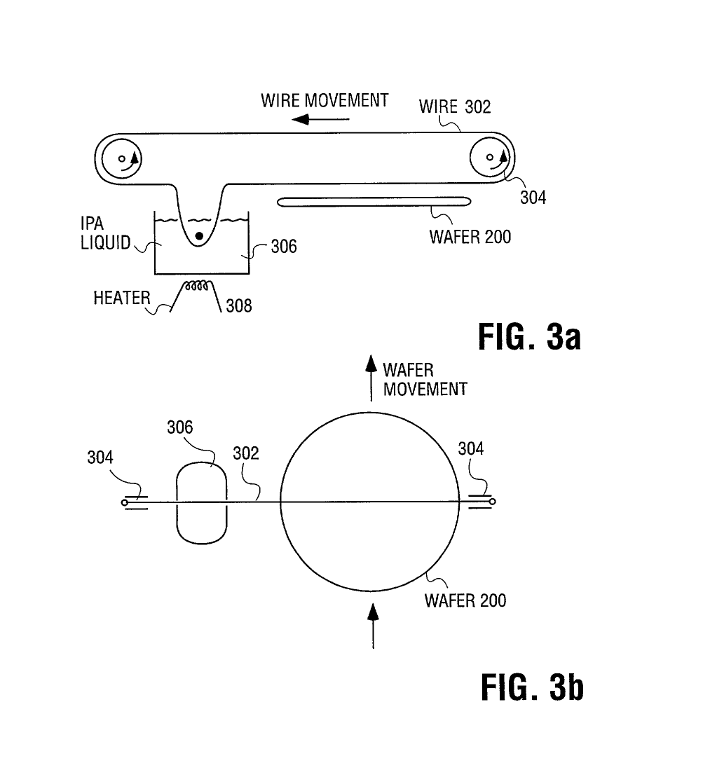

It is to be appreciated that although IPA is the preferred solvent for removing adhered moisture from a wafer, other solvents having lower surface tension than water can be used. FIG. 3a is a cross-sectional view and FIG. 3b is overhead view of an embodiment of an IPA linear vapor source in accordance with the present invention. As shown in FIG. 3a and FIG. 3b a linear source of IPA can be made by a rope or wire 302 which is saturated or drenched in IPA. The wire or rope 302 is made of a solvent absorbing material. The wire or rope 302 can be run by a wheel 304. On one side the rope or wire 302 passes through a liquid source of IPA 306. Passing the wire 302 through the liquid IPA 306 will keep the wire or rope saturated with IPA. As the wheels 304 turn they pass the saturated wire of IPA over the wafer surface. The IPA will evaporate and create a local IPA vapor which adheres on the wafer surface when the wafer 200 is passed underneath. Additionally, if desired, a heater 308 can be provided to heat the IPA liquid source to a temperature between 30-70° C. in order to increase saturation of the wire or rope with IPA.

Alternatively, the rope itself acts as a capillary and even when held stationary will suck up IPA from a reservoir in which it is soaked on one or both ends through the capillary action.

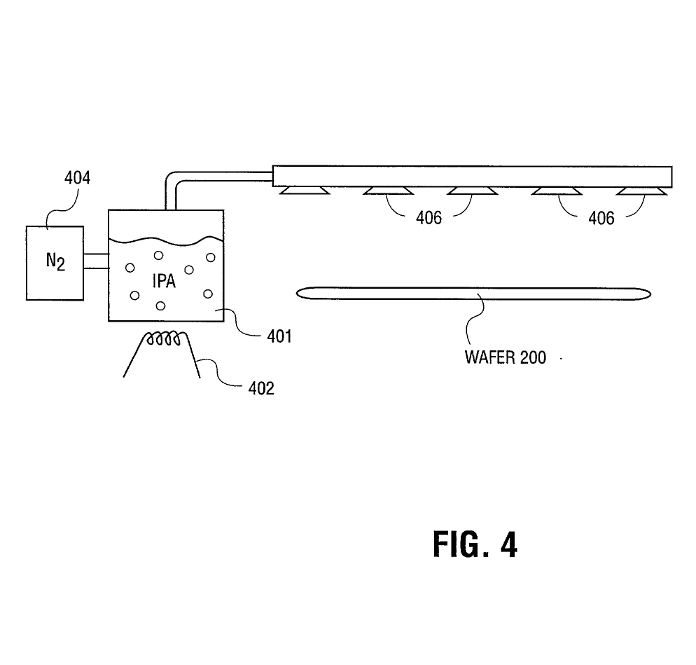

FIG. 4 is a cross-sectional view of an alternative linear source of IPA in accordance with an embodiment of the present invention. As shown in FIG. 4, IPA vapor can be generated remotely by heating pure IPA liquid 401 with a heater 402 and/or by bubbling N₂ 404 into liquid IPA 401. The N₂ 404 is then used as a carrier gas for the IPA. The IPA liquid 401 through which N₂ is bubbled can be heated by heater 402 to increase the concentration of IPA in the N₂ carrier gas. The IPA vapor can then be released through a linear array of point nozzles 406 or through a single slit nozzle.

Thus, a method and apparatus for removing adhered moisture from wafer has been described.

We claim:

1. A method of reducing adhered moisture from a wafer comprising:
spinning a wafer to dry said wafer; and
after spinning said wafer dry, passing said wafer under a isopropyl alcohol (IPA) vapor source.

2. A method of reducing adhered moisture on a wafer comprising:
placing a wafer on a rotatable wafer support in a single wafer cleaning apparatus;
exposing said wafer to a liquid to rinse said wafer;
spinning said wafer to dry said wafer; and
while removing said wafer from said cleaning apparatus passing said wafer under a linear source of isopropyl alcohol (IPA) vapor.

3. The method of claim 2 wherein said wafer is passed under said linear source of isopropyl alcohol (IPA) vapor at a rate of approximately 900 cm/minutes.

4. The method of claim 2 wherein said linear source of isopropyl alcohol (IPA) vapor source comprises a wire or rope saturated with isopropyl alcohol (IPA).

5. The method of claim 2 wherein said linear source of isopropyl alcohol (IPA) vapor is formed by bubbling N₂ through liquid isopropyl alcohol (IPA) and using said N₂ as a carrier gas for said isopropyl alcohol (IPA) and flowing said isopropyl alcohol (IPA) in the N₂ carrier gas through a nozzle.

6. A cleaning apparatus comprising:
a rotatable wafer support for spinning a wafer about its central axis; and
a linear source of isopropyl alcohol (IPA) vapor.

7. The apparatus of claim 6 wherein said linear source of isopropyl alcohol (IPA) vapor comprises isopropyl alcohol (IPA) solvent absorbing material; and
a isopropyl alcohol (IPA) liquid reservoir where said isopropyl alcohol (IPA) solvent absorbing material passes through said isopropyl alcohol (IPA) liquid reservoir.

8. The apparatus of claim 6, wherein said linear source of isopropyl alcohol (IPA) vapor comprises isopropyl alcohol (IPA) solvent absorbing material; and
wherein the isopropyl alcohol (IPA) solvent absorbing material sucks up the isopropyl alcohol (IPA) from one or 2 reservoirs through the capillary action.

9. The apparatus of claim 7 further comprising a heater for heating said isopropyl alcohol (IPA) liquid in said reservoir.

10. The apparatus of claim 8 further comprising a heater for heating said isopropyl alcohol (IPA) liquid in said reservoir.

11. The apparatus of claim 6 wherein said linear source of isopropyl alcohol (IPA) vapor comprises a slit nozzle.

12. The cleaning apparatus of claim 6 wherein said linear source of isopropyl alcohol (IPA) vapor comprises a linear array of point nozzles.

13. The cleaning apparatus of claim 6 wherein said linear source of isopropyl alcohol (IPA) vapor includes a isopropyl alcohol (IPA) liquid reservoir in which N₂ gas is bubbled.
